(19) United States
(12) Patent Application Publication
(10) Pub. No.: US 2013/0126747 A1
(43) Pub. Date: May 23, 2013

(54) RADIOGRAPHIC APPARATUS HAVING REDUCED RADIOLOGICAL DOSAGE

(71) Applicants: Geun-Chang Lee, Daejeon (KR); Won-Ky Kim, Hwaseong-si (KR)

(72) Inventors: Geun-Chang Lee, Daejeon (KR); Won-Ky Kim, Hwaseong-si (KR)

(21) Appl. No.: 13/641,123

(22) PCT Filed: Apr. 23, 2010
(86) PCT No.: PCT/KR2010/002518

§ 371 Date: Dec. 17, 2012

(30) Foreign Application Priority Data
Apr. 16, 2010 (KR) 20-2010-0004023

(51) Int. Cl. G01N 23/04

(52) U.S. Cl. CPC G01N 23/04
USPC 250/393

(57) ABSTRACT

A radiographic apparatus includes a radiation tube, a collimator and a camera. The radiation tube radiates a radiation. The collimator is attached to the radiation tube. The camera is attached to the collimator to provide an image to a user before a radiation field reaches a target organ. The radiation field is defined by the radiation passing through the collimator.

This application claims priority to Korean Utility Model Application No. 20-2010-0004023, filed on Apr. 16, 2010, and all the benefits accruing therefrom under 35 U.S.C. §119, the contents of which in its entirety is herein incorporated by reference.

### BACKGROUND OF THE INVENTION

1. Field of the Invention

Example embodiments of the present invention relate to a radiographic apparatus. More particularly, example embodiments of the present invention relate to a radiographic apparatus having reduced radiological dosage.

2. Description of the Related Art

Generally, using a radiographic apparatus connected to a screen, a radiation should be radiated to a patient to display an image of a patient on a screen. However, the image is necessary to find a target organ when moving a radiation field. Accordingly, the radiation is radiated to the patient until the radiation field reaches the target organ of the patient, and thus an excessive radiation may be exposed to the patient.

### BRIEF SUMMARY OF THE INVENTION

Example embodiments of the present invention provide a radiographic apparatus capable of reducing radiological dosage.

In an example embodiment of a radiographic apparatus according to the present invention, the radiographic apparatus includes a radiation tube, a collimator and a camera. The radiation tube radiates a radiation. The collimator is attached to the radiation tube. The camera is attached to the collimator to provide an image to a user before a radiation field reaches a target organ. The radiation field is defined by the radiation passing through the collimator.

According to the example embodiments of the present invention, the radiation is radiated to a patient after a radiation field reaches a target organ of the patient, and thus the radiation exposed to the patient may be decreased.

### BRIEF DESCRIPTION OF THE DRAWINGS

The above and other features and advantages of the present invention will become more apparent by describing in detailed example embodiments thereof with reference to the accompanying drawings, in which:

FIG. 1 is a conceptual diagram illustrating a radiographic apparatus according to an example embodiment of the present invention.

### DETAILED DESCRIPTION OF THE INVENTION

Hereinafter, example embodiments of the present invention will be described in further detail with reference to the accompanying drawings.

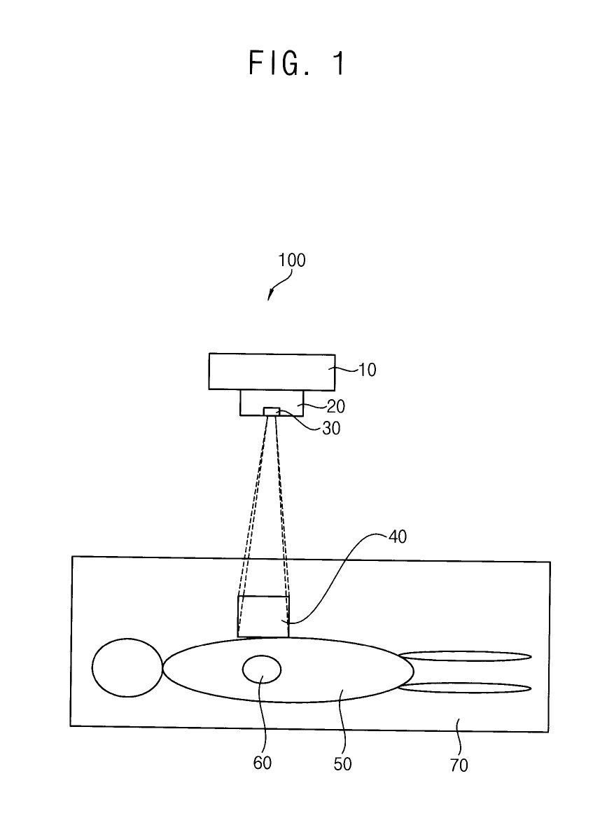

FIG. 1 is a conceptual diagram illustrating a radiographic apparatus according to the present example embodiment.

Referring to FIG. 1, the radiographic apparatus 100 according to the present example embodiment includes a radiation tube 10, a collimator 20 and a camera 30.

The radiation tube 10 radiates a radiation. The collimator 20 is attached to the radiation tube 10. The camera 30 is attached to the collimator 20.

The camera 30 is aligned with a radiation field 40. The radiation field 40 is defined by the radiation passing through the collimator 20 and is an area in which the radiation is radiated, as illustrated in FIG. 1. An image displayed until the radiation field 40 is coincided with a target organ 60 of a patient 50 is not generated by the radiation, but by the camera 30 which does not radiates the radiation. Thus, the radiation is not exposed to the patient until the radiation field 40 is coincided with the target organ 60 of the patient 50. The radiation is not radiated when the radiation field 40 moves to find the target organ 60 of the patient 50. Thus, the radiation is exposed only to the target organ 60 of the patient 50 after the radiation field 40 is positioned and coincided with the target organ 60. For example, the camera 30 may be a closed circuit television (CCTV), and provides an image to a screen through which a user finds the target organ 60.

According to the example embodiments of the present invention, the radiation is radiated to a patient after a radiation field reaches a target organ of the patient, and thus the radiation exposed to the patient may be decreased.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific example embodiments disclosed, and that modifies to the disclosed example embodiments, as well as other example embodiments, are intended to be included within the scope of the appended claims. The present invention is defined by the following claims, with equivalents of the claims to be included therein.

What is claimed is:

1. A radiographic apparatus comprising:
a radiation tube radiating a radiation;
a collimator attached to the radiation tube; and
a camera attached to the collimator to provide an image to a user before a radiation field reaches a target organ, the radiation field being defined by the radiation passing through the collimator.
